(19) United States
(12) Patent Application Publication
(10) Pub. No.: US 2012/0158429 A1
(43) Pub. Date: Jun. 21, 2012

(54) MEDICAL SERVICE BROKER SYSTEMS AND METHODS

(76) Inventors: David Phillip Murawski, Barrington, IL (US); Christopher Puryear, Barrington, IL (US); Wendy Bohner, Barrington, IL (US)

(21) Appl. No.: 12/973,511

(22) Filed: Dec. 20, 2010

(51) Int. Cl. G06Q 50/00; G06Q 10/00

(52) U.S. Cl. 705/3; 705/2

(57) ABSTRACT

Medical service broker systems and methods are described. An example computer-implemented method of soliciting bids for a medical service includes receiving patient data including patient identifying information and accepting a patient request for a first medical service. The example method includes facilitating the creation of a first profile based on the requested first medical service and de-identifying the first profile by anonymizing the patient identifying information. The example method includes conveying the first profile to one or more first providers to solicit one or more bids to perform the first medical service and receiving one or more bids from the one or more providers and displaying for selection.

### BACKGROUND

In some instances, a patient may want to receive a quote for a medical service. However, to receive such a quote, the patient may spend large amounts of time contacting numerous different providers that may or may not provide the services being sought by the patient.

### SUMMARY

An example computer-implemented method of soliciting bids for a medical service includes receiving patient data including patient identifying information and accepting a patient request for a first medical service. The example method includes facilitating the creation of a first profile based on the requested first medical service and de-identifying the first profile by anonymizing the patient identifying information. The example method includes conveying the first profile to one or more first providers to solicit one or more bids to perform the first medical service and receiving one or more bids from the one or more providers and displaying for selection.

A medical service broker system includes a data storage to store data including information associated with patient private information, and a patient medical service request. The example medical service broker system includes a broker including a processor to receive input from an access device associated with the patient medical service request. The processor to facilitate the generation a patient profile based on the patient medical service request, the patient profile being de-identified from the patient private information. The processor to convey the patient medical service request and the patient profile to one or more providers to solicit a bid to perform the patient medical service request. The processor further to receive input from the one or more providers associated with the bid to perform the patient medical service request and display bid to the patient.

An example tangible computer-readable storage medium including executable instructions for execution using a processor, wherein the instructions, when executed, provide a system to solicit bids for medical services. The system includes a receiver to receive patient data and a patient request for a medical service and a generator to facilitate the generation of a profile based on at least one of the requested medical service, or the patient data. The system includes a de-identifier to de-identify the profile from the patient data and a solicitor to solicit one or more bids from one or more providers based on the profile and the requested medical service.

### BRIEF DESCRIPTION OF THE DRAWINGS

FIG. 1 is a block diagram of an medical service broker system.

FIG. 2 is a block diagram of an example apparatus that may be used to implement the examples described herein.

FIG. 3 is a flow diagram of an example method that can be used to implement the examples described herein.

FIG. 4 is a schematic illustration of an example processor platform that may be used and/or programmed to implement any or all of the example methods and systems described herein.

The foregoing summary, as well as the following detailed description of certain examples, will be better understood when read in conjunction with the appended drawings. For the purpose of illustrating the examples described herein, certain examples are shown in the drawings. It should be understood, however, that the present disclosure is not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

When any of the appended claims are read to cover a purely software and/or firmware implementation, at least one of the elements in at least one example is hereby expressly defined to include a tangible medium such as a memory, DVD, CD, Blu-ray, etc. storing the software and/or firmware.

The examples systems and methods described herein relate to example medical service brokers that facilitate quotes being received safely and anonymously for requested medical services from one or more vendors of patient care (e.g., doctors, facilities, pharmacies, etc.). The quotes received enable patients requesting care to make educated choices on care to be received. The vendors may be doctors, healthcare organizations, pharmacies, etc., and the quotes may be related to a medical service, a prescription to be filled (e.g., a 30 day supply, a 60 day supply, a 90 day supply), etc.

In some examples, a patient may access a web page hosted by and/or associated with the examples described and request one or more medical services (e.g., emergency room visit, outpatient visit, strep test, ear infection, etc.). Patient private information obtained from the patient, a provider, an insurance company, etc. may be received to facilitate the generation of a profile(s). The profile may include information typically used by a provider to formulate a bid based on the requested medical service(s), a patient preference(s), a medical history, insurance specification(s), etc. The patient private information may be stored at and/or accessible to the example medical service broker.

Based on the requested medical service, the examples described may request and/or obtain different data to facilitate the generation of and/or organization of a profile. In some examples, the examples described may automatically generate a profile based on a requested medical service from the patient private information. To enable the automatic generation of a profile based on a requested medical service, the examples described may similarly code and/or use universal terms for similar data associated with the obtained patient private information. For example, the examples described may code information relating to high blood pressure similarly to information relating to hypertension. Thus, even if patient data is differently formatted or if different terminology is used, the examples described can automatically generate a profile based on the same and/or convert the patient data and/or add a term(s) to the patient data such that patient data is universally coded. In some examples, if the examples described automatically generate a profile based on a requested medical service, the generated profile may be displayed to the patient for approval.

The information included in different profiles may be different based on the specific medical service requested such that data not needed to formulate a bid is not typically included. For example, a profile generated for a medical service request to remove a wart may not include information relating to a patient's pervious knee surgery. The information included in a profile may include a patient's current condition, symptoms, age, sex, allergies, medical history, insurance information, doctor and/or family preferences, etc. or, more generally, information typically used by a provider when formulating a bid for the medical service requested. The preferences may be related to the patient preferring a female doctor over a male doctor and/or preferring a doctor that speaks a particular language such as Spanish.

The profile(s) may be a general medical profile and may be used for different requested medical services. For example, a general profile may be used for medical services relating to a patient having a sore throat. Additionally or alternatively, the profile(s) may be more specific and may just be used for more specific medical services. For example, an emergency profile may be used for medical services relating to a hurt leg or a child in need of stitches.

Regardless of the type of profile set up, the examples described may de-identify the profile from the patient private information to enable the generated profile to be conveyed and/or passed around to different vendors of patient care without the vendors knowing the patient's identity and/or private information. Thus, based on a requested medical service, the examples described facilitate the solicitation of and/or negotiation of one or more quotes and/or bids from vendors of patient care while still being in compliance with the Health Insurance Portability and Accountability Act (HIPAA). In some examples, an identifier such as a random number may be associated with the profile and the patient after the profile has been de-identified to ensure patient anonymity.

In some examples, the general profile including the de-identified data may be conveyed to a first group of vendors of patient care to solicit first bids and the emergency profile including the de-identified data may be conveyed to a second group of vendors of patient care to solicit second bids. The first group may be the same as the second group. Alternatively, the first group may be partially or completely different than the second group. The medical group(s) to which bids are solicited may be based on criteria such as the medical service requested, the patient's insurance, the location of the patient, other preferences, etc.

The quotes received from the vendors may include a variety of information such as an exact cost or an estimated cost for a medical service, distance or a route to a provider, wait time for a provider and/or other amenities. Additionally or alternatively, the quote may include information relating to whether or not the provider accepts the patient's insurance, if the provider offers discounts or price breaks (e.g., if you pay cash) and/or if the provider has equipment and/or an amenity to perform a proper diagnosis (e.g., light to detect a scratched cornea).

In some examples, if a patient accepts one of the bids, the patient may be provided with a license number or key that can be later used to facilitate scheduling and/or obtaining the accepted bid price for the medical service. In some examples, if the patient accepts one of the bids, the examples described may convey the patient acceptance to the vendor associated with the accepted bid. In some examples, if the patient accepts one of the bids, the examples described may convey at least some non-de-identified data to the vendor associated with the accepted bid. For example, based on the patient accepting one of the bids, the examples described may convey patient identifying data to the vendor associated with the accepted bid.

If the request is related to a prescription being filled, once a profile is generated/retrieved and de-identified associated with the prescription request, the profile, the prescription request and/or other information may be conveyed to pharmacies and/or providers to solicit bids. A bid(s) received may be conveyed to the requestor (e.g., a patient) for approval.

In some examples, revenue may be generated from vendors that subscribe to the examples described. In some examples, revenue may be generated from advertisements posted in connection with the examples described. In some examples, revenue may be generated based on vendors having a bid accepted by a patient.

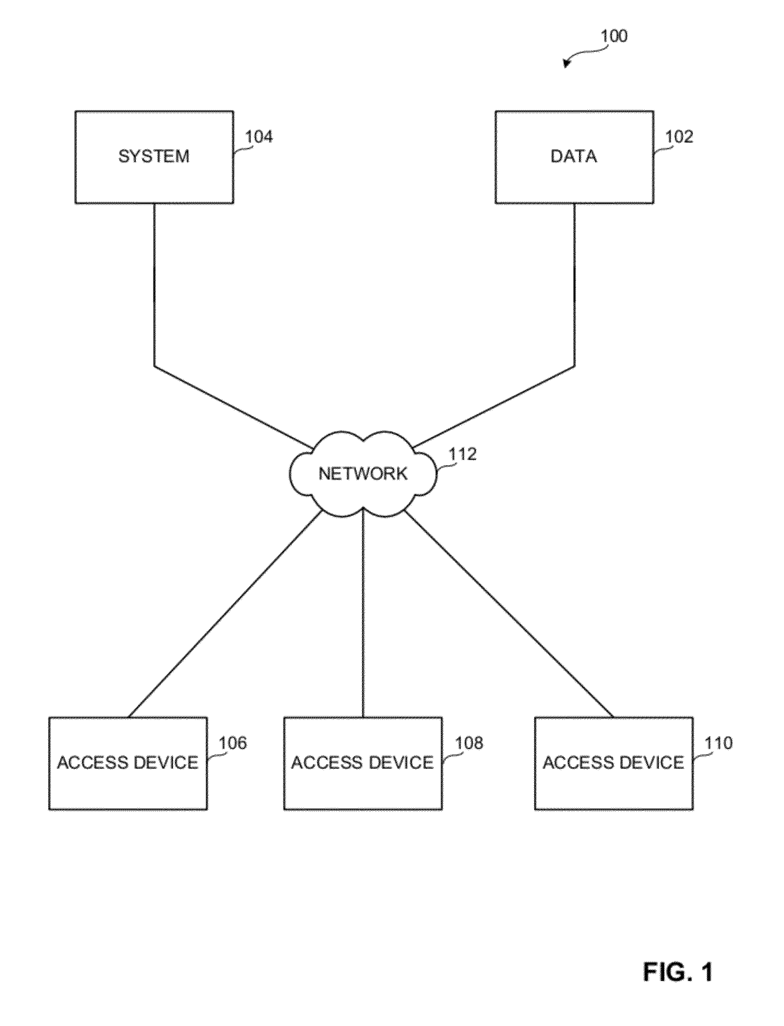

FIG. 1 depicts an example medical service broker system 100 including a data store or source 102 and a system 104. One or both of the data source 102 and/or the system 104 may interact with a first access device 106, a second access device 108 and/or a third access device 110. In some examples, the data source 102 and/or the system 104 can be implemented in a single system. In some examples, the data source 102 and/or the system 104 can communicate with one or more of the access devices 106-110 via a network 112. In some examples, one or more of the access devices 106-110 can communicate with the data source 102 and/or the system 104 via the network 112. In some examples, the access devices 106-110 can communicate via the network 122. The network 112 may be implemented by, for example, the Internet, an intranet, a private or personal network, a wired or wireless Local Area Network, a wired or wireless Wide Area Network, a cellular network and/or any other suitable network.

The data source 102 can provide a patient profile including de-identified patient data and/or a patient request to the access devices 106-110 to solicit receiving one or more bids to perform a medical service. In some examples, the data source 102 can receive information associated with the patient profile including de-identified patient data and/or a patient request from one of the access devices 106-110. Based on the solicitation of the one or more bids, the data source 102 may receive one or more bids from, for example, healthcare providers associated with a respective one of the access devices 106-110. The system 104 can provide a patient profile including de-identified patient data and/or a patient request to the access devices 106-110 to solicit receiving one or more bids to perform a medical service. In some examples, the system 104 can receive information associated with the patient profile including de-identified patient data and/or a patient request from one of the access devices 106-110. Based on the solicitation of the one or more bids, the system 104 may receive one or more bids from, for example, healthcare providers associated with a respective one of the access devices 106-110. The data source 102 and/or the system 104 can be implemented using a system such as PACS, RIS, HIS, CVIS, EMR, archive, data warehouse, etc.

The access devices 106-110 can be implemented using a workstation (e.g., a laptop, a desktop, a tablet computer, etc.) or a mobile device, for example. Some mobile devices include smart phones (e.g., BlackBerry™, iPhone™, etc.), Mobile Internet Devices (MID), personal digital assistants, cellular phones, handheld computers, tablet computers (iPad™), etc., for example. In some examples, the access devices 106-110 may be located at or associated with a healthcare provider or organization.

In some instances, a patient may want to receive bids for a medical service to be performed and/or a prescription to be filled, for example. However, to receive such bids, patients typically have to divulge private information to providers that may lead to future solicitation. Additionally, to receive such bids, patients may spend large amounts of time contacting numerous different providers that may or may not provide the services being sought by the patient, for example.

In such instances, using the examples described herein, the access devices 106-110, the data source 102 and/or the system 104 may interact to efficiency enable bids to be solicited, received and/or accepted for a medical service sought, a patient request, a prescription request, etc. For example, based on the data source 102 and/or the system 104 receiving a patient request to have a physical performed, the data source 102 and/or the system 104 may perform processes to generate and/or retrieve an anonymous profile used to solicit bids from providers at the second and third access devices 108 and/or 110 and convey any bids received to perform the patient's request to the patient at the first access device 106. The anonymous profile may be associated with having a physical performed and may include de-identified patient private information. In some examples, based on receiving an acceptance of one of the bids from the patient at the first access device 106, the data source 102 and/or the system 104 may perform processes to schedule the patient for an appointment at the provider associated with the accepted bid. In some examples, based on receiving an acceptance of one of the bids from the patient at the first access device 106, the data source 102 and/or the system 104 may perform processes to convey non-de-identified patient private information to the provider associated with the accepted bid.

In some examples, if a patient wants to receive a bid to have a physical performed (e.g., requested medical service), the patient may access a web page associated with the data source 102 and/or the system 104 at the first access device 106 and input a request for a physical. Once the request is received, the data source 102 and/or the system 104 may open an entry relating to the requested service and/or interact with the patient at the first access device 106 to generate and/or retrieve a profile based on the requested medical service.

In some examples, the data source 102 and/or the system 104 may generate the profile automatically based on private information of the patient stored at and/or accessible to the data source 102 and/or the system 104. The patient private information may be input to the data source 102 and/or the system 104 by the patient and/or any organization (e.g., a healthcare organization, an insurance provider, etc.). In some examples, the data source 102 and/or the system 104 may provide the patient at the access device 106 with a fillable template based on the requested medical service. In some examples, the patient may fill out the template based on information inputted by the patient and/or private information of the patient stored at and/or accessible to the data source 102 and/or the system 104. However, in other examples, based on previous interactions with the data source 102 and/or the system 104, a profile usable for the requested service may have been previously generated and, thus, the data source 102 and/or the system 104 may retrieve the previously generated profile based on patient's request. For example, a general profile previously generated by the patient to solicit, receive and/or accept bids to have a strep test performed may also be usable by the patient to solicit, receive and/or accept bids to have a physical performed.

Once the profile has been generated and/or a previously generated profile has been located and/or retrieved, the data source 102 and/or the system 104 may de-identify the profile from the patient. For example, the data source 102 and/or the system 104 may redact and/or remove any identifying information from the profile such as the patient's name, the patient's address, the patient's social security number, etc. In some examples, de-identifying the patient profile includes adding an anonymous identifier to the profile associated with the patient and the patient private information used to generate the profile. The de-identified profile and/or the requested medical service may be conveyed by the data source 102 and/or the system 104 to identified providers at the second access device 108 and/or the third access device 110. In some examples, the providers to which the profile and/or the request is conveyed may be based on their ability to perform the requested medical service. In some examples, the providers to which the profile and/or request is conveyed may be based on their association with a healthcare network. In some examples, the providers to which the profile and/or request is conveyed may be based on their ability to accommodate the patient's preferences.

The providers may review the patient profile and/or the patient request at the second and/or third access devices 108 and/or 110 and, if they are interested in performing the requested service, the respective provider may input a bid into the second and/or third access device 108 and/or 110 that is then conveyed to the data source 102 and/or the system 104. The bid(s) may include a cost to perform the requested service, when the next available time slot to have the service performed is, the amount of wait time at the respective provider, etc. The received bid(s) and its associated information may be conveyed by the data source 102 and/or the system 104 to the patient at the first access device 106.

The patient may receive a notice of receiving a bid by e-mail, text message, etc. After reviewing the bid(s) received, the patient may accept one of the bids using the access device 106 and information related to the patients acceptance may be conveyed to the data source 102 and/or the system 104. In some examples, if the patient accepts one of the bids, the data source 102 and/or the system 104 may close the entry relating to the requested service. In some examples, if the patient accepts one of the bids, the data source 102 and/or the system 104 may facilitate scheduling an appointment for the patient at the provider associated with the accepted bid. For example, if the second provider at the second access device 108 is associated with the accepted bid, the data source 102 and/or the system 104 may convey a key or identifier relating to the accepted bid to the second provider and/or the patient at the first access device 106 relating to the accepted bid. Additionally or alternatively, if the second provider at the second access device 108 is associated with the accepted bid, the data source 102 and/or the system 104 may interact with the provider at the second access device 108 and the patient at the first access device 106 to identify a time at which both the provider and the patient are available to schedule an appointment. In some examples, if the patient accepts one of the bids, the data source 102 and/or the system 104 may convey non-de-identified data to the provider associated with the accepted bid. The non-de-identified data may be data typically used by a provider when performing the requested service.

However, if the patient chooses not to accept any of the bids and/or if a predetermined time has elapsed, the data source 102 and/or the system 104 may solicit additional bids from other providers at fourth and fifth access devices (not shown), prompt the patient at the first access device 106 via text message, e-mail, etc. to determine if the patient needs additional time to determine whether or not to accept one of the bids received and/or close the entry relating to the requested medical service.

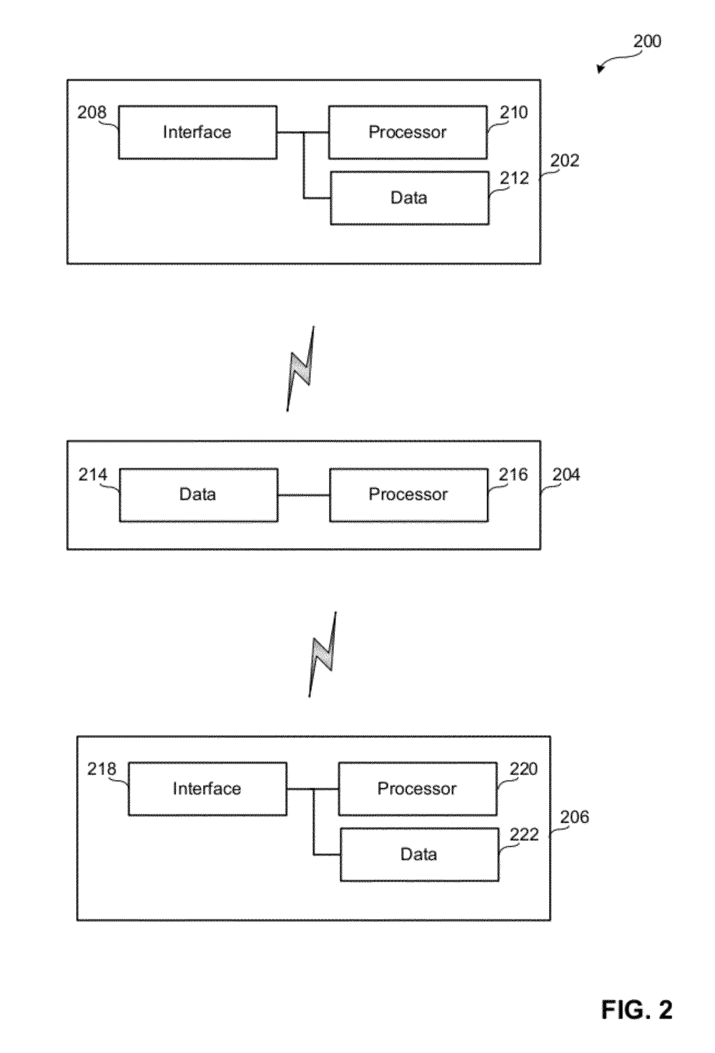

FIG. 2 depicts a block diagram of an example medical service broker system 200 including an example first access device 202, an example medical service broker 204 and an example second access device 206. The first access device 106 may be used to implement the first access device 106 of FIG. 1. The medical service broker 204 may be used to implement the data source 102 and/or the system 104 of FIG. 1. The second access device 206 may be used to implement the second access device 108 of FIG. 1.

The first access device 202 may include an interface 208, a processor 210 and a data source 212. The medical service broker 204 may include a data source 214 and a processor 216. The second access device 206 may include an interface 218, a processor 220 and a data source 222. While an example of implementing the data source 102 and/or the system 104 and the access devices 106 and 108 of FIG. 1 have been illustrated in FIG. 2, one or more of the elements, processes and/or devices illustrated in FIG. 2 may be combined, divided, re-arranged, omitted, eliminated and/or implemented in other ways. In some examples, the processor 210 may be integrated into the interface 208 and/or the data source 212. Additionally or alternatively, in some examples, the processor 216 may be integrated into the data source 214. Additionally or alternatively, in some examples, the processor 220 may be integrated into the interface 218 and/or the data source 222. The interfaces 208 and/or 218, the processors 210, 216 and/or 220 and/or the data sources 212, 214 and/or 222 and, more generally, the example the example medical service broker system 200 may be implemented by hardware, software, firmware and/or a combination of hardware, software and/or firmware. Thus, the interfaces 208 and/or 218, the processors 210, 216 and/or 220 and/or the data sources 212, 214 and/or 222 and, more generally, the example medical service broker system may be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the interfaces 208 and/or 218, the processors 210, 216 and/or 220 and/or the data sources 212, 214 and/or 222 and, more generally, the example medical service broker system 200 are hereby expressly defined to include a tangible medium such as a memory, DVD, CD, Blu-ray, etc., storing the software and/or firmware. Further still, the example medical service broker system 200 of FIG. 2 may include one or more elements, processes and/or devices in addition to, or instead of, those illustrated in FIG. 2, and/or may include more than one of any or all of the illustrated elements, processes and devices.

The access devices 202 and 206 and the medical service broker 204 include the processors 210, 216 and/or 220 retrieving data, executing functionality and storing data at the respective access devices 202 or 206, the medical service broker 204, the data source 102 of FIG. 1 and/or the system 104 of FIG. 1. The processors 210, 220 drive respective interfaces 208 and 218 providing information and functionality to a user input to control the access devices 202 and 206, request a medical service, place a bid to perform a medical service, create a profile, edit information, accept a bid for the medical service, etc. In some examples, the interfaces 208 and/or 218 may be configured as a graphical user interface (GUI). The GUI may be a touch pad/screen integrated with and/or attached to the respective access devices 202 and/or 206. In some examples, the interfaces 208 and/or 218 may be a keyboard, mouse, track ball, microphone, etc. In some examples, the processors 210, 216 and/or 220 may implement a receiver to receive patient data and a patient request for a medical service. In some examples, the processors 210, 216 and/or 220 may implement a generator to facilitate the generation of a profile based on a requested medical service and/or patient data. In some examples, the processors 210, 216 and/or 220 may implement a de-identifier to de-identify the profile from the patient data. In some examples, the processors 210, 216 and/or 220 may implement a solicitor to solicit one or more bids from one or more providers based on a profile and/or a requested medical service.

The access devices 202 and 206 and the medical service broker 204 include one or more internal memories and/or data stores including the data sources 212, 214 and 222. Data storage can include any variety of internal and/or external memory, disk, remote storage communicating with the access devices 202 and/or 206 and/or the medical service broker 204.

The processor 210, 216 and/or 220 can include and/or communicate with a communication interface component to query, retrieve, and/or transmit data to and/or from the first access device 202 and the second access device 206, the medical service broker 204, the data source 102 of FIG. 1 and/or the system 104 of FIG. 1, for example. Using user input received via the interface 208 as well as information and/or functionality from the data source 212, the processor 210 can convey a request to the medical service broker 204. The request may be a medical service request, a request to have a prescription filled or any other type of request in which people may want to receive bids for the request discreetly and/or anonymously. In some examples, the request may include user preferences such as providers within a particular distance of the user, providers having extended hours, providers having less than a particular wait time, providers that typically provide the requested service within a particular price range, a day, date and/or time that the patient is available, providers that accept the patients insurance, etc.

The processor 216 may determine the appropriate profile to solicit bids based on the request. If the request is related to a sore throat, the appropriate profile may be a general medical profile. If the request is related to receiving an emergency appendix surgery, the profile may be an emergency medical profile. Depending on the profile determined to be appropriate, the processor 216 may search the data source 214 and/or another data base accessible to the processor 216 to determine if the appropriate profile has been previously created for the user.

In some examples, if the appropriate profile has not been previously created, the processor 216 may automatically generate a profile based on patient private information stored at the data source 214 and convey the same to the first access device 202 where the generated profile may be displayed at the interface 208 for user approval. In some examples, if the appropriate profile has not been previously created, the processor 216 may convey a profile template to the access device 202 and provide the user access to private information of the user to be used to fill out the template. The private information of the user may be stored at the data source 214. The template, once completed, may be conveyed to the medical service broker 204 from the first access device 202 for storage at the data source 214.

Regardless of how the template is obtained and/or created, the profile associated with the request may be de-identified and then conveyed to providers that may have the resources to fulfill the user's request. For example, if the request is a medical service request to have a physical performed and the provider at the second access device 206 is a family physician, the processor 216 may convey the request and the associated profile to the provider at the second access device 206 to solicit a bid to perform the requested medical service. However, if the request is a medical request to have brain surgery and the provider at the second access device 206 is a family physician, the processor 216 may not convey the request and the associated profile to the provider at the second access device 206.

Using user input received via the interface 218 as well as information and/or functionality from the data source 222, the processor 220 can convey a bid to perform the medical service to the medical service broker 204 which in turn may be conveyed to the first access device 202. In some examples, the bid may include the cost to perform the medical service, a list of services provided at the bid price, and/or a time frame that the bid may be accepted prior to its expiration. In some examples, the bid may include limitations on the medical service(s) received such as limiting the time at which the provider is willing to perform the medical request at the bid price to an unpopular time of day.

Using user input received via the interface 208 as well as information and/or functionality from the data source 212, the processor 210 can convey an acceptance of the received bid to the medical service broker 204 which in turn may be conveyed to the provider at the second access device 206. In some examples, based on receiving the user's acceptance, the processor 216 may convey non-de-identified data to the provider at the second access device 206. In some examples, based on receiving the user's acceptance, the processor 216 may convey a license number or key to the user at the first access device 202 and/or the provider at the second access device 206 to ensure that the terms of the accepted bid are upheld when the request is fulfilled. In some examples, based on receiving the user's acceptance, the processor 216 may facilitate scheduling the user for an appointment.

In some examples, the medical service broker 204 may convey tracking information to the first and/or second access devices 202 and/or 206. The tracking information may be related to previous requests made by the user and/or other users. The tracking information may be related to previous bids made by the provider and/or other providers. The tracking information may be related to previous bids accepted by the user and/or other users. In some examples, the tracking information may include the average bid price accepted for the requested service and/or the average bid price made for the requested service. In some examples, based on the tracking information, the medical service broker 204 may suggest a price to the patient and/or the provider at the respective access device 202 and/or 206.

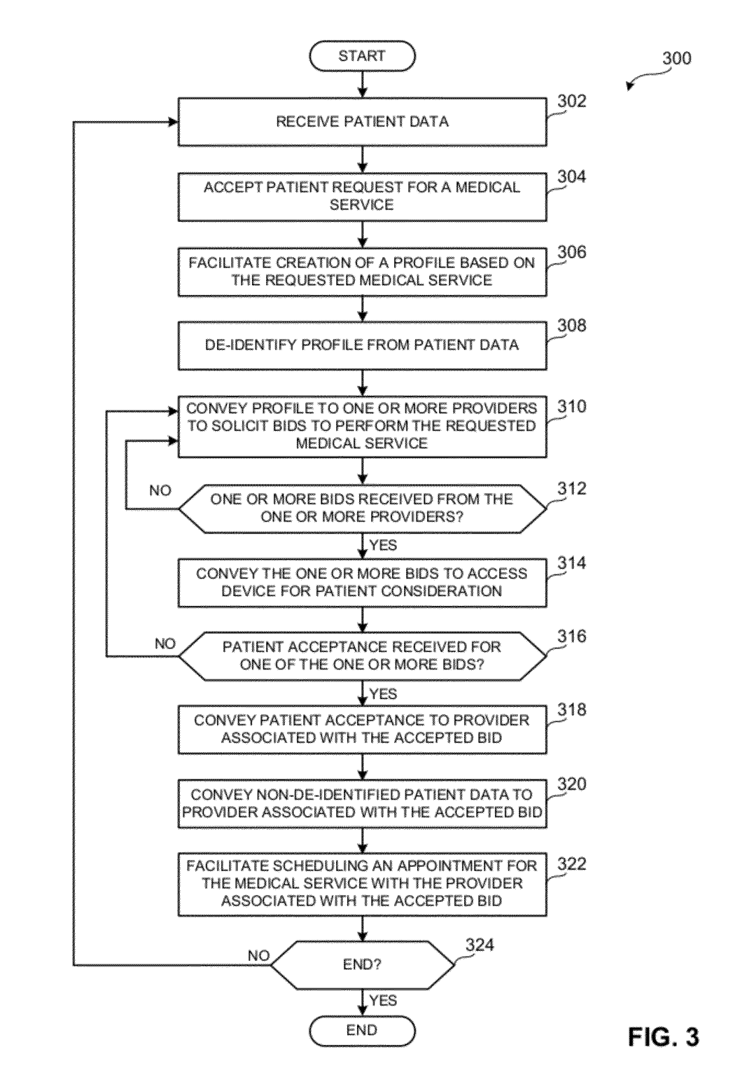

FIG. 3 depicts an example flow diagram representative of processes that may be implemented using, for example, computer readable instructions that may be used to broker medical requests using one or more access devices, a medical service broker, a data store and/or a system. The example processes of FIG. 3 may be performed using a processor, a controller and/or any other suitable processing device. For example, the example processes of FIG. 3 may be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIG. 3 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIG. 3 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIG. 3 may be implemented manually or as any combination(s) of any of the foregoing techniques, for example, any combination of firmware, software, discrete logic and/or hardware. Further, although the example processes of FIG. 3 are described with reference to the flow diagrams of FIG. 3, other methods of implementing the processes of FIG. 3 may be employed. For example, the order of execution of the blocks may be changed, and/or some of the blocks described may be changed, eliminated, sub-divided, or combined. Additionally, any or all of the example processes of FIG. 3 may be performed sequentially and/or in parallel by, for example, separate processing threads, processors, devices, discrete logic, circuits, etc.

FIG. 3 relates to an example method 300 of brokering medical service request and bids to perform the same. At block 302, the method 300 receives patient data. The patient data received may include patient private information such as a patient's medical history. The patient data may be received from patient input accessing a website associated with the examples described or from any other source. At block 304, the example method 300 may accept a patient request for a medical service. The patient may request a medical service by logging into a secure website associated with the examples described and selecting an aliment from a menu and/or by submitting a description of the request sought.

At block 306, the method 300 may facilitate the creation of a profile based on the requested medical service. In some examples, the method 300 may facilitate the generation of a profile based on the requested medical service by identifying information typically used by a medical provider when formulating a bid to perform the requested medical service. In some examples, the method 300 may facilitate the generation of a profile based on the requested medical service by providing the patient with a fillable form associated with the requested medical service. In some examples, the method 300 may facilitate the generation of a profile based on the requested medical service by automatically generating the profile based on the patient data received.

At block 308, the method 300 de-identifies the profile from the patient data. For example, the method 300 may remove any identifying and/or personal information from the profile. At block 310, the method 300 may convey the de-identified profile and/or the medical service request to one or more providers to solicit bids to perform the requested medical service. In some examples, the providers to which the profile is conveyed may have been previously selected by the patient as being a preferred list of providers. In some examples, the providers to which the profile is conveyed may accept the patient's insurance. In some examples, the providers to which the profile is conveyed may be within a particular distance (e.g., 15-miles) of the patient's location. For example, if the patient requests a medical service using a mobile device, the providers to which the profile is conveyed may be based on the patient's current location as input into the mobile device and/or identified via the mobile device (e.g., GPS). Thus, if the mobile device identifies the patient's location as being in Michigan after receiving a patient medical request, the profile may be conveyed to Michigan providers and/or if the mobile device identifies the patient's location as being in Illinois after receiving a patient medical request, the profile may be conveyed to Illinois providers.

At block 312, the method 300 determines whether or not one or more bids have been received from the one or more providers. If no bids have been received, control returns to block 310. However, if one or more bids have been received, control advances to block 314, and the one or more bids are conveyed to an access device for patient consideration. (block 314). In some examples, the patient may be notified of a bid being received by text message, instant message, e-mail, calling, etc.

At block 316, the method 300 determines if patient acceptance has been received for one of the one or more bids. In some examples, the patient may accept one of the bids by using a GUI of a mobile device. At block 318, the method 300 may convey the patient acceptance to the provider associated with the accepted bid. At block 320, the method 300 may convey non-de-identified patient data to the provider associated with the accepted bid. At block 322, the method 300 may facilitate scheduling an appointment for the medical service associated with the accepted bid. At block 324, the method 300 determines whether or not to return to block 302. Otherwise the example method 300 is ended.

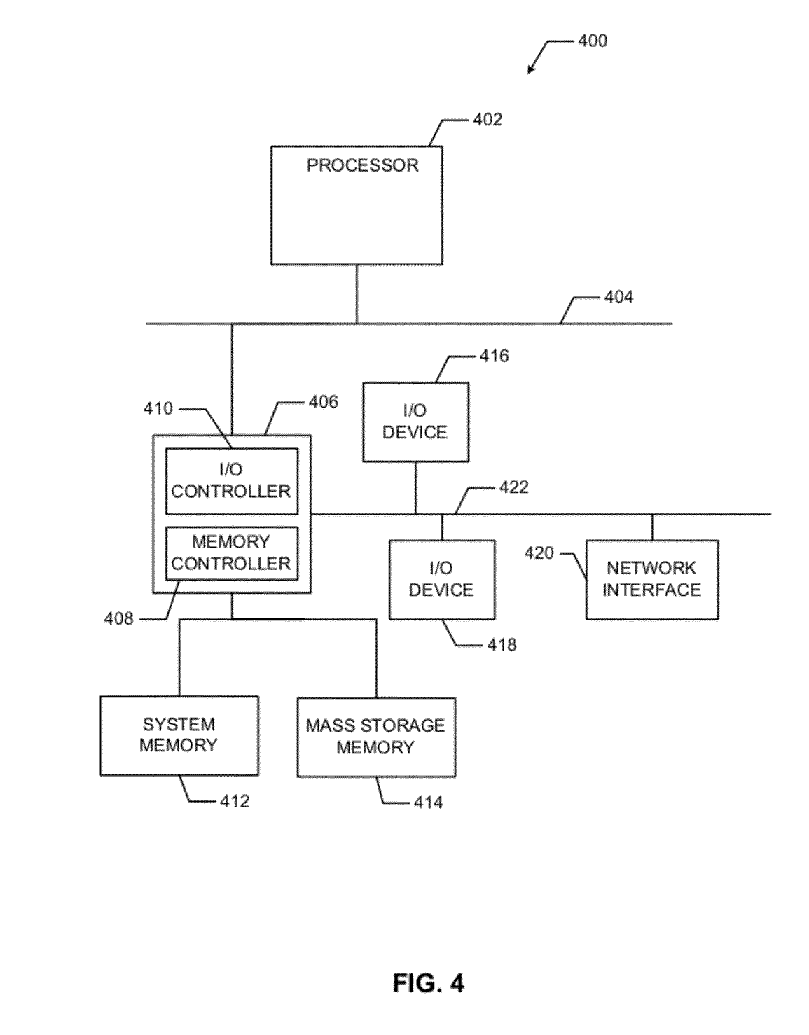

FIG. 4 is a block diagram of an example processor system 400 that may be used to implement the systems and methods described herein. As shown in FIG. 4, the processor system 400 includes a processor 402 that is coupled to an interconnection bus 404. The processor 402 may be any suitable processor, processing unit or microprocessor. Although not shown in FIG. 4, the processor system 400 may be a multi-processor system and, thus, may include one or more additional processors that are identical or similar to the processor 402 and that are communicatively coupled to the interconnection bus 404.

The processor 402 of FIG. 4 is coupled to a chipset 406, which includes a memory controller 408 and an input/output (I/O) controller 410. As is well known, a chipset typically provides I/O and memory management functions as well as a plurality of general purpose and/or special purpose registers, timers, etc. that are accessible or used by one or more processors coupled to the chipset 406. The memory controller 408 performs functions that enable the processor 402 (or processors if there are multiple processors) to access a system memory 412 and a mass storage memory 414.

The system memory 412 may include any desired type of volatile and/or non-volatile memory such as, for example, static random access memory (SRAM), dynamic random access memory (DRAM), flash memory, read-only memory (ROM), etc. The mass storage memory 414 may include any desired type of mass storage device including hard disk drives, optical drives, tape storage devices, etc.

The I/O controller 410 performs functions that enable the processor 402 to communicate with peripheral input/output (I/O) devices 416 and 418 and a network interface 420 via an I/O bus 422. The I/O devices 416 and 418 may be any desired type of I/O device such as, for example, a keyboard, a video display or monitor, a mouse, etc. The network interface 420 may be, for example, an Ethernet device, an asynchronous transfer mode (ATM) device, an 802.11 device, a DSL modem, a cable modem, a cellular modem, etc. that enables the processor system 400 to communicate with another processor system.

While the memory controller 408 and the I/O controller 410 are depicted in FIG. 4 as separate blocks within the chipset 406, the functions performed by these blocks may be integrated within a single semiconductor circuit or may be implemented using two or more separate integrated circuits.

The examples described relate to medical service brokers that facilitate anonymous requests being made for medical services and bids being received and accepted to perform such medical services. In some examples, the requests may include information such as the medical service to be performed, the time that the patient is available to have the medical service performed, the price that the patient is willing to pay for the medical service and/or the distance that the patient is willing to travel to a provider. In some examples, the bids received may include information such as the price to perform the medical service, an itemized explanation of the procedures performed for the bid price and/or the availability of the provider at the bid price, etc.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer-implemented method of soliciting bids for a medical service, comprising:
receiving patient data including patient identifying information;
accepting a patient request for a first medical service;
facilitating the creation of a first profile based on the requested first medical service;
de-identifying the first profile by anonymizing the patient identifying information;
conveying the first profile to one or more first providers to solicit one or more bids to perform the first medical service; and
receiving one or more bids from the one or more providers and displaying for selection.

2. The method of claim 1, wherein the one or more bids comprises at least one of a cost for the first medical service, a wait time for the first medical service, a distance to the respective first provider, an amenity of the respective first provider, a discount granted by the respective first provider, or insurance coverage for the first medical service.

3. The method of claim 1, further comprising receiving a patient acceptance of one of the one or more bids.

4. The method of claim 3, further comprising conveying the patient acceptance to the provider associated with the accepted bid.

5. The method of claim 4, the patient acceptance being associated with a confirmation number to facilitate scheduling an appointment.

6. The method of claim 3, further comprising providing the provider associated with the accepted bid with non-de-identified patient data.

7. The method of claim 3, further comprising facilitating scheduling an appointment based on the receipt of the patient acceptance.

8. The method of claim 1, wherein the patient data is associated with at least one of a name, patient identifying data, a symptom, an age, a sex, an allergy, a medical history, insurance information, or a preference.

9. The method of claim 1, further comprising:
accepting a patient request for a second medical service, the second medical service being different than the first medical service;
facilitating the creation of a second profile based on the requested second medical service, the second profile being at least partially different than the first profile;
de-identifying the second profile from the patient data; and
conveying the second profile to one or more second providers to solicit one or more bids to perform the second medical service.

10. The method of claim 9, the first profile being associated with a general health profile and the second profile being associated with a specific health profile.

11. The method of claim 1, wherein facilitating the creation of the first profile comprises automatically generating the first profile based on the patient data.

12. The method of claim 11, further comprising receiving a patient confirmation of the accuracy of the first profile.

13. The method of claim 1, the patient data being received from at least one of a patient, a provider, or an insurance company.

14. The method of claim 1, further comprising coding the patient data such that similar data is similarly coded.

15. A medical service broker system, comprising:
a data storage to store data including information associated with patient private information, and a patient medical service request, and
a broker including a processor to receive input from an access device associated with the patient medical service request; the processor to facilitate the generation a patient profile based on the patient medical service request, the patient profile being de-identified from the patient private information; the processor to convey the patient medical service request and the patient profile to one or more providers to solicit a bid to perform the patient medical service request; the processor further to receive input from the one or more providers associated with the bid to perform the patient medical service request and display bid to the patient.

16. The system of claim 15, the processor further to receive input from the first access device to accept the one of one or more bids received from the respective provider.

17. The system of claim 16, the processor further to facilitate scheduling the patient for the requested medical service at the provider associated with the accepted bid.

18. The system of claim 16, the processor further to convey de-identified data associated with at least one of the patient profile or the patient private information to the provider associated with the accepted bid.

19. A tangible computer-readable storage medium including executable instructions for execution using a processor, wherein the instructions, when executed, provide a system to solicit bids for medical services, the system comprising:
a receiver to receive patient data and a patient request for a medical service;
a generator to facilitate the generation of a profile based on at least one of the requested medical service, or the patient data;
a de-identifier to de-identify the profile from the patient data; and
a solicitor to solicit one or more bids from one or more providers based on the profile and the requested medical service.

20. The tangible computer-readable storage medium of claim 20, wherein the receiver is to further receive one or more bids from the one or more providers.

21. The tangible computer-readable storage medium of claim 21, wherein the receiver is to further receive a patient acceptance of one of the one or more bids.

22. The tangible computer-readable storage medium of claim 21, further comprising a transmitter to transmit at least some non-de-identified patient data to the provider associated with the accepted bid.
